(19) United States
(12) Patent Application Publication
(10) Pub. No.: US 2007/0271466 A1
(43) Pub. Date: Nov. 22, 2007

(54) SECURITY OR AUTHENTICATION SYSTEM AND METHOD USING MANUAL INPUT MEASUREMENTS, SUCH AS VIA USER MANIPULATION OF A COMPUTER MOUSE

(76) Inventors: Genevieve Mak, Vancouver (CA); Martin Renaud, Maple Ridge (CA); Andrew Csinger, Vancouver (CA)

Correspondence Address: PERKINS COIE LLP;PATENT-SEA, P.O. BOX 1247, SEATTLE, WA, 98111-1247, US

(21) Appl. No.: 11/747,729

(22) Filed: May 11, 2007

Related U.S. Application Data
(60) Provisional application No. 60/801,691, filed on May 18, 2006.
(60) Provisional application No. 60/801,979, filed on May 18, 2006.

(51) Int. Cl. H04K 1/00

(52) U.S. Cl. 713/184

(57) ABSTRACT

A method and system for analyzing user input for security, authentication or other purposes includes displaying an objective for a user to pursue and receiving user input via a user input device as the displayed objective is pursued, wherein the user input includes manual manipulation of a user input device, such as a mouse. The received user input is then compared to a user profile representing prior manual manipulation of the user input device in pursuit of the displayed objective. Other features and functions are also disclosed, including a method to improve security by permitting multilingual users to employ an alternative language when responding to on-screen prompts.

### CROSS REFERENCE TO RELATED APPLICATION(S)

This application claims priority to U.S. Provisional Patent Application Nos. 60/801,691, filed 18 May 2006, entitled “Cognometrically Indexed Gestural Biometrics,” and 60/801,979, filed 18 May 2006, entitled “Alternative Language Authentication,” (attorney docket nos. 60783.8003 and 60783.8004, respectively).

### BACKGROUND

Security systems use authentication mechanisms to help protect valuable electronic information, restrict access to confidential areas, and to otherwise secure virtual or physical locations. These authentication mechanisms include passwords, cards (e.g., debit and credit cards with magnetic stripes, smart cards), etc, which are all designed to vet the identity of an individual user: if the user has the appropriate password, card or token, that user is considered legitimate. Because authentication mechanisms can routinely be compromised, many systems also employ authentication-monitoring methods that attempt to indicate fraudulent authentication attempts; for example, credit card companies employ a geographical tracking method that assesses the likelihood that a user would be authenticating from a particular location. These methods can quickly identify certain kinds of fraudulent authentication attempts, such as when an account is simultaneously accessed in both New York and Los Angeles; the system can decide that at least one of the transactions is fraudulent, and then notify the system administrator.

Authentication monitoring methods like geographical tracking offer the advantage of being minimally intrusive to legitimate users; the methods themselves are transparent to the user, imposing no additional restrictions, requirements, or risks. New techniques of fraud detection must also meet this bare minimum barrier to entry in the market: they must work efficiently and silently in the background, beyond the user's awareness, and yet still guard effectively against fraud.

Authentication solutions such as passwords or personal identification numbers (PINs) are susceptible to “brute force”—in other words, a program can be created to attempt all possible combinations of characters. Other threats include keyboard loggers, which log passwords as they are entered. Hence the system cannot be sure that there is actually a person entering the password, and if there is, then it may not be the person authorized to use the PIN or password. Similarly, hardware tokens are susceptible to fraudulent use if not assiduously guarded.

Biometric hardware solutions have been developed to try and combat the security problems associated with passwords, PINs, and tokens; for example: fingerprint scanners, iris scanners, and facial recognition. Generally, these solutions require expensive hardware and/or other related costs, making many of these solutions too expensive to purchase or implement for smaller scale systems. The hardware often has unsatisfactory serviceability and accuracy rates, and generally requires user training. Some of these solutions require complicated instructions, while others require several attempts in order to make a positive identification.

The technologies that are currently used to monitor and detect system threats are static and unresponsive to the daily changing threat levels in a system—they compare identities against a single template that does not reflect changes in age or physiology. The static criterion, are set long before the threat occurs, either on a weekly or daily basis rather than in real time. Modern computing speeds, however, enable a widespread multi-layered attack to occur within hours or perhaps even minutes. Preset static criteria present a security risk that an attacker can capitalize on through strategic modification of the type of attack to determine the criterion and prepare a sophisticated learned attack strategy to gain entry. Multiple static criterions, for a range of simple security mechanisms, one of which may be geo-location tracking, present multiple targets for such a strategic attack. Security threats are routinely initiated as attacks directed at one or more levels within a network. A threat could be directed principally at a small number of accounts (as often happens in brute force password cracking), or could be directed system wide (as often happens with DOS (denial of service) and DDOS (distributed denial of service) attacks).

Overall, there is a need in the marketplace for new authentication monitoring technology that can further detect fraudulent authentication activity, provide flexible monitoring criteria, assess the threat level, make appropriate reports, and adjust appropriately to the assessed threat level. As stated above, it must be easy to use, affordable, accurate, and transparent to the user.

### BRIEF DESCRIPTION OF THE DRAWINGS

FIG. 1 is a block diagram of a computer that may employ aspects of an authentication system.

FIG. 2 is a block diagram illustrating a computing system in which aspects of the authentication system may operate in a networked environment.

FIG. 3 is a flow diagram of suitable steps that can be performed under one embodiment of the invention.

FIG. 4 is an example of pseudocode for computing heat graph parameters.

FIG. 5 is an example of pseudocode for providing low, medium and high scores under the routine of FIG. 3.

FIG. 6 is an example of pseudocode for determining click or cursor drift.

FIG. 7 is an example of pseudocode for implementing a two-dimensional click analysis routine that may be employed by the routine of FIG. 3.

FIG. 8 is an example of a display screen for gathering mouse clicks.

FIGS. 9A and 9B are examples of process flow under an alternative or natural language authentication routine.

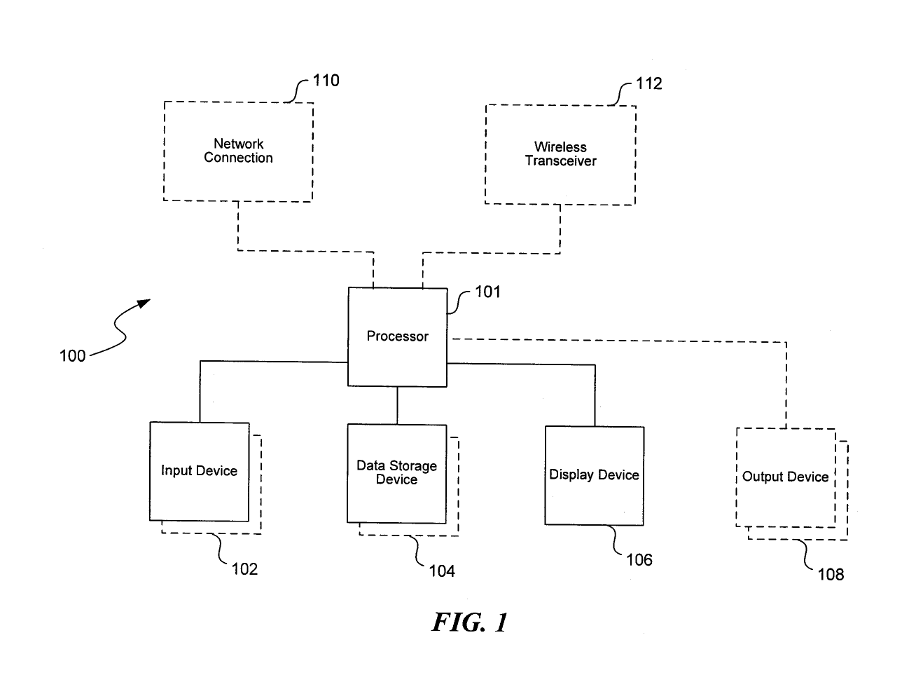

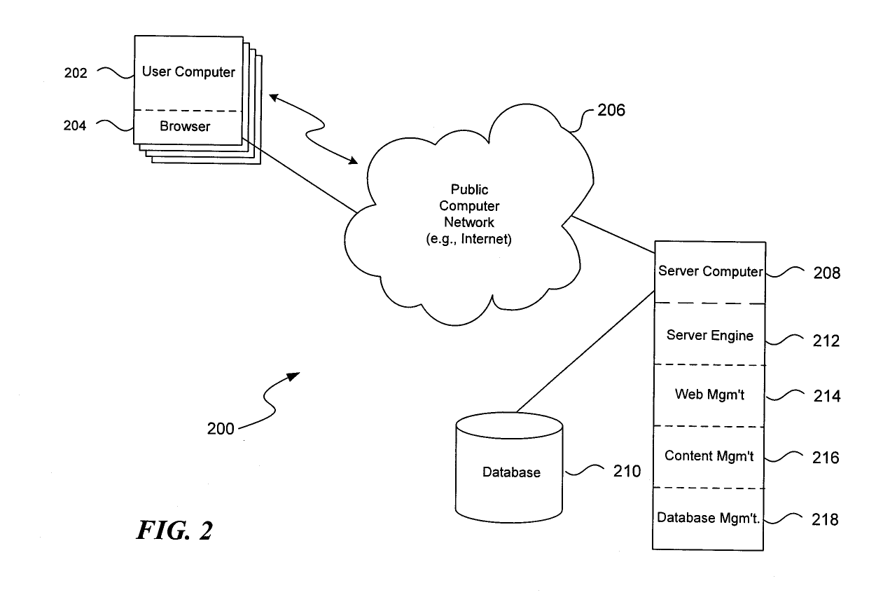

### DETAILED DESCRIPTION

If a person intending fraudulent authentication comes into the unauthorized possession of authentication mechanisms, such as passwords, debit and credit cards with magnetic stripes, smart cards, etc, then an affordable, reliable, and accurate biometric authentication monitoring system provides a second line of defense. Information and financial institutions are searching for such new methods to help ensure and maintain security; however, as discussed above, static monitoring criteria can still involve significant vulnerabilities.

The system described below addresses these and other concerns: it is an affordable authentication monitoring system that avoids common biometric pitfalls by measuring, recording, and using both cognitive and gestural data, as well as biometric data. The system is simple, efficient, and effective for authenticating individuals with high person-present reliability. By requiring a user to interact with, understand, and react appropriately to the system not only provides a biometric solution, but also provides a combined biometric, gestural, and cognometric solution. This system requires no specialized hardware, and can depend only upon a unique combination of individual cognition and individual kinesthetic traits which together constitute a biometric. A cognitive component may be elicited and bound to kinetics using a challenge-response technique.

Various embodiments or examples of the invention will now be described. (The terms “embodiment” and “example” are often used interchangeable below.) The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

### I. Representative Computing Environment

The following discussion provides a general description of a suitable computing environment or system in which aspects of the invention can be implemented. Although not required, aspects and embodiments of the invention will be described in the general context of computer-executable instructions, such as routines executed by a general-purpose computer, e.g., a server or personal computer. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor.

The system can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

The system employs at least one computer 100, such as a personal computer or workstation, with at least one processor 101, and is coupled to one or more user input devices 102 (described below) and data storage devices 104. The computer is also coupled to at least one output device such as a display device 106, and may be coupled to one or more optional additional output devices 108 (e.g., printer, plotter, speakers, tactile or olfactory output devices, etc.). The computer may be coupled to external computers, such as via an optional network connection 110, a wireless transceiver 112, or both.

The input devices may include a keyboard as well as a pointing device such as a mouse or other manual input device that a user may manipulate, either directly or indirectly. In one example, the user input device is a mouse, but similar pointing and selecting devices may be used, such as a track ball, pen (often employed with a tablet), touch pad, touch-sensitive screen, joystick, etc. The system may also employ a motion sensing device that monitors movement of a user's hand or other body part (either directly, or via a physical device held by or secured to the user). Other input devices are also possible such as a microphone, game pad, scanner, digital camera, video camera, and the like.

The data storage devices may include any type of computer-readable media that can store data accessible by the computer, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet. As will become apparent below, aspects of the invention may be applied to any data processing device. For example, a mobile phone may be secured with only the addition of software stored within the device—no additional hardware is required. The software may be stored within non-volatile memory of the phone, possibly even within the subscriber identity module (SIM) of the phone, or stored within the wireless network.

Aspects of the invention may be practiced in a variety of other computing environments. For example, a distributed computing environment including one or more user computers 202 in a system, each of which includes a browser module 204. Computers may access and exchange data over a computer network 206, including over the Internet with web sites within the World Wide Web. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. Web browsers, or any application program for providing a graphical or other user interface to users, may be employed.

At least one server computer 208, coupled to a network, performs much or all of the functions for receiving, routing and storing of electronic messages, such as web pages, audio signals, and electronic images. Public networks or a private network (such as an intranet) may be preferred in some applications. The network may have a client-server architecture, in which a computer is dedicated to serving other client computers, or it may have other architectures such as a peer-to-peer, in which one or more computers serve simultaneously as servers and clients. A database 210 or other storage area coupled to the server computer(s) stores much of the web pages and content exchanged with the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer may include a server engine 212, a web page management component 214, a content management component 216, and a database management component 218. The server engine performs basic processing and operating system level tasks. The web page management component handles creation and display or routing of web pages. Users may access the server computer by means of a URL associated therewith. The content management component handles most of the functions in the embodiments described herein. The database management component handles storage and retrieval tasks with respect to the database, queries to the database, and storage of data such as video, graphics and audio signals.

### II. Suitable Implementation and Overview

One embodiment of the invention, described in detail below and sometimes referred to as “Mousemetrics,” or “Cognometrically Indexed Gestural Biometrics”, is a computer-implemented system that monitors and assesses user response parameters, and compares them against previously stored parameters associated with that user. The stored parameters are measured during user initialization, and are constantly updated as more user response data is collected. The response parameters to be recorded may include response time to a query, cursor movement patterns, cursor movement rates, cursor hover patterns, clicking patterns, rate of curvature in cursor movement, etc. The responses are measured during user authentication sessions, are transparent to the user, and are stored in the associated user profile. Using various methods, described below, the current response parameters are compared against previously-stored parameters. This provides an additional level of security, in addition to the authorization mechanism(s) that the user is both conscious of and responding to.

One example of the system involves measuring mouse or other pointer movement as the user traces a path displayed on the screen. The paths to be traced may be explicit (system-defined for the user) or implicit (only start and end points defined by the system); in the following examples, three types of paths are described—two explicit and one implicit—however one skilled in the art would recognize that other path types and measurements are possible. The paths discussed here are: over a line or curve; within specified borders; or from one target to another. In the case of targets, the user clicks on each target in a series, with the targets appearing as recognizable and clickable features (such as on-screen buttons).

Users can be identified by the way they trace a path and select the targets. The way in which a user follows or traces a displayed path (implicit or explicit) with an input device and selects targets is a biometric. Recognizing what is on the screen, understanding it, and reacting appropriately all require cognition, and hence can be measured as a cognometric. This embodiment is also gestural since the input device records user gestures in response to displayed stimulus.

Using the input device to trace a curve with the cursor or pointer is an example of an explicit path. A line drawing is displayed on screen, such as with defined start and stop locations. The user is then instructed by the system use the input device to trace over the drawing with the cursor.

Using the input device to follow an enclosed on-screen path (such as a maze) is another example of an explicit path. The user must follow the path from start to finish with the cursor, without overstepping the boundaries of the path. The screen with the image may be static or dynamic. The view of the path may be overhead, first person or be from any number of other perspectives. The user may control a cursor or a moving on-screen object (such as in a car-racing game).

Using the input device to establish a target driven path is an example of an implicit path. Using the input device, users click buttons, icons, or pictures of any size and in any location on the screen. The targets can have text, or images, or both, and can be of any size or shape. The buttons can be in random locations, or at the same locations every session. The user is supposed to click on the “correct” button at a given time; the correct button may have a certain colour, text or image to identify it. Buttons can appear and disappear on the screen at random time intervals or in groups.

While buttons are described below in several examples, aspects of the invention could be applied to any objectives displayed to users on a screen or display device where users manipulate an input device to pursue the objectives. The displayed objectives could be any targets, buttons, questions, or any graphic representation needed to prompt user responses for recording and comparison. Of course, each display screen may include instructions for the user (although such instructions may be provided audibly).

While examples of the system are described herein as manipulating a cursor, the term “cursor” is used for convenience: under aspects of the invention, users may manipulate any input device to provide input to move or change something displayed on a display screen. Further, while examples of the system are described herein as analyzing clicks, the term “click” is used for convenience: under aspects of the invention, users may provide any type of input selection via any input device to provide selection of something displayed on a display screen, only one example of which is a mouse click (actuation of a button on a mouse).

The input device can be any device that is part of, attached to, or otherwise communicates with a system capable of accepting input. The input device can track movement, clicks, mouse wheel movement, other button movement, or any other inputs. It can detect motion and inputs using any method—optical LEDs, laser, mechanical sonar, radio waves, GPS, etc. It can be—but is not limited to—mouse, trackball, keyboard, stylus on a pressure sensitive pad, touch sensitive screen, trackpad, any motion detecting or pointing device, etc.

The data points that may be recorded are: the coordinates (e.g. x, y, z etc.) of the cursor on the screen with respect to time; the force that the user applied (with or without a pointing device) in moving the cursor, with respect to time; and any other input data from any input device. These data points can be taken at regularly or randomly spaced intervals.

Cognitively indexed gestural biometrics allows for: the input device to change between sessions; changes in the expected path from session to session; dynamic changes in the expected path during the session; and changes in users over time. The embodiment itself is dynamic, continuously updating itself after every session, and hence continuously improving in terms of accuracy.

### III. Examples of Implementation and Calculations

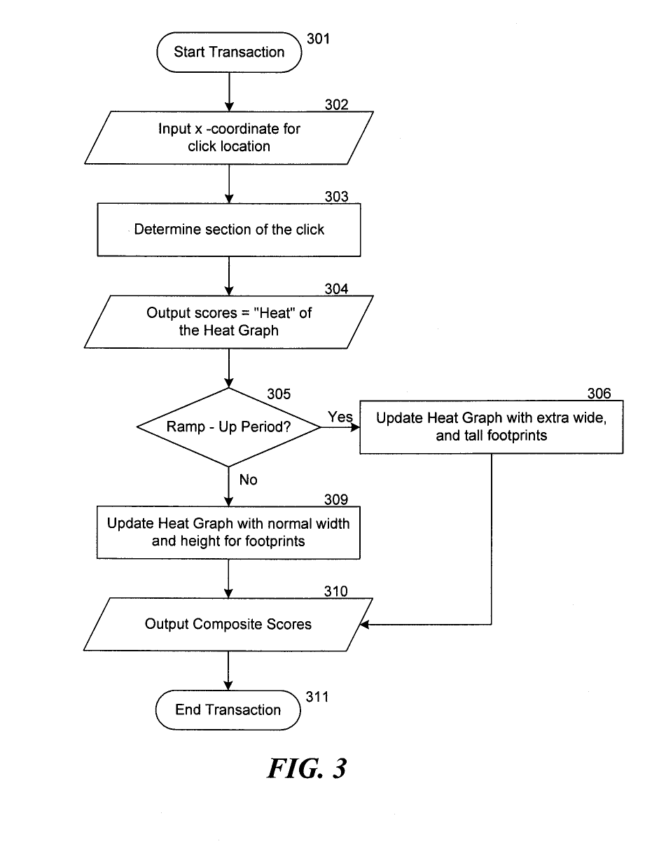

Several example implementations of one suitable embodiment of the invention will be described in connection with the flowchart shown in FIG. 3. It will be obvious to one skilled in the relevant art that this description is one of numerous potential ways the current system can be applied. Similarly, alternative embodiments can be envisioned that produce different data or summary outputs than those specifically described here.

Under the system and routine of FIG. 3, the user may be asked to answer one or more multiple choice questions. The routine begins in block 301 where an authentication transaction is initiated. In block 302, the system receives an input x-coordinate for a location where a user has clicked a mouse or otherwise provided a selection input. In an optional block 303, the system determines which portion or section of a location on a display device the click was received. For example, as is described in greater detail below, the system may divide an input button into several sections, which can speed processing, reduce data storage, etc.

In block 304, the system outputs a score that can represent an intensity or “heat” for a heat graph, as described below. In block 305, the system determines whether an initialization or ramp-up period is currently engaged, as is also described in greater detail below. If so, then in block 306, the system employs or accepts an enlarged acceptable or target area, such as input buttons having extra wide and tall footprints, and updates the heat graph accordingly. If not, then in block 309 the system updates the heat graph with normal width and height footprints. In block 310 the system outputs a composite score, as described below, and the transaction ends in block 311. Subsequent processing may be performed to analyze the output composite score to determine whether to authenticate a given login attempt or other transaction.

The system may employ the question types described in U.S. patent application Ser. No. 11/608,186, filed 7 Dec. 2006, entitled “AUTHENTICATION SYSTEM EMPLOYING USER MEMORIES”, and is referenced below by the acronym “PROM” (Presence of Mind authentication system). PROM is a computer-implemented system having a user interface to capture information about events that the user may have experienced. In an initialization phase, a user enters information related to a particular theme that he or she is familiar with. The theme may be a life event that the user has personally experienced, a category of information that is known to the user, a well-known event that the user is likely to be familiar with, or any other set of information that the user would be able to consistently recollect. The user's familiarity with the theme is captured using a querying system, such as one that generates queries about five main components of a theme: who, what, when, why, and where. Responses to the queries may be entered by a user using a mouse-over event, mouse click, or other user input mechanism (e.g. touch screen). The user's responses to the queries are stored in a user profile. The user is subsequently authenticated if the user is able to replicate the information stored about a theme in the user profile.

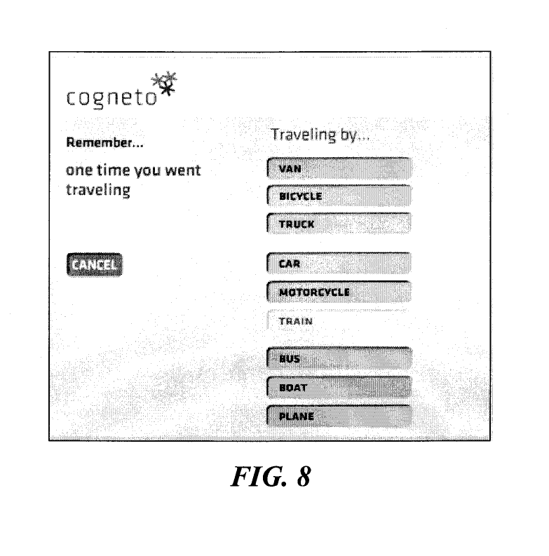

The set of relevant responses may be displayed to the user in the form of a linear vertical grid, or in another form that allows the user to quickly identify an appropriate response. FIG. 8 shows an example of such a user input screen having a question (“One time you went traveling by . . . ”), and a vertical column of target buttons. Each response selected by the user may be used to generate the next question and list of potential responses, allowing the system to quickly record a set of user-entered responses corresponding to the remembered event. The set of user responses may be stored by the system in a profile associated with the user. Users may be asked to perform the initialization phase more than once so as to establish a profile containing responses to two or more themes. The themes may be related to one-another in content, or may have dissimilar content. During later authentication phases, the questions are again displayed, but with responses rearranged from when they were presented during authentication, and may include additional “incorrect” responses.

One example implementation involves the well known web usage measuring concept of the “heat graph.” A heat graph or heat map is a two-dimensional representation of an intensity typically localized in a smaller central area representing greater intensity, and having lesser intensity extending outward with appropriate contour lines representing different levels of intensity. Such a heat graph can provide a two-dimensional Gaussian representation of user inputs under the system described herein.

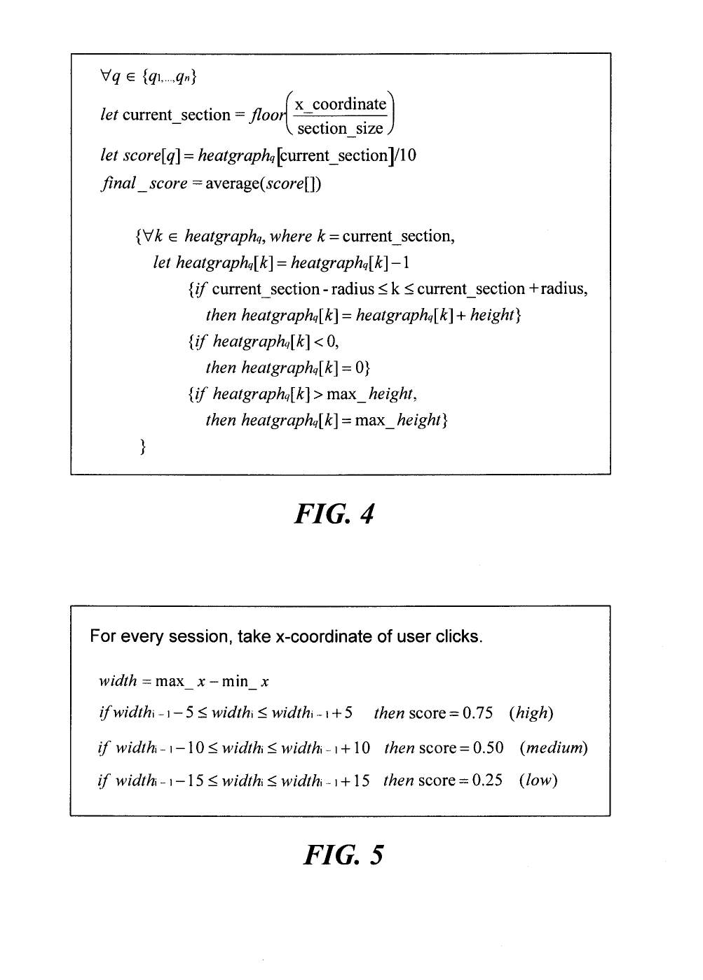

Using the PROM interface forces users to click on a series of buttons; these buttons are randomly placed in one of 9 positions during each authentication phase. This particular embodiment determines, recognizes, or authenticates a user based on where they click relative to a target button, where the target button is a button selected or clicked on by a user. For every target button the user clicks, an x coordinate is recorded for that click location; the x coordinate is measured relative to the left extent of the target button. This current x coordinate is compared to those recorded in the user profile, and a score is established between 0 and 1 where: 0 indicates that past patterns are not matched, and 1 indicates that past patterns are matched perfectly. For example, in order to save memory space, a 165 pixel button may be divided into sections of 5 pixels, starting at 0. If the recorded x coordinate equals 44, then the click is in section 8—since floor (44/5)=8. If the recorded x coordinate was 3, then it would fall in section 0 since floor (3/5)=0. FIG. 4 shows an example of pseudocode for implementing a subroutine to compute heat graph parameters.

The system computes or gathers user input for each user selection or target button on which the user clicks. Each input may be divided, such that the click section is calculated for every target, or question, and the scores are the “heat” in the heat graph for that section. The heat graph is then updated. Thus, a separate heat graph may be computed for not only each user, but each question or screen that a user may interact with. As a user repeats common tasks through similar screens, each session with each screen is compared to previous sessions for those same screens so that common inputs may be appropriately compared or correlated to generate heat graphs or other data collections to assign probabilities for user input associated with particular users (and stored in their appropriate user profiles).

During the initialization or ramp up period (in some embodiments, before 5 successful recognitions), the heat graph is given an extra wide and tall footprint in order to compensate for sparse data. After the ramp up period, the footprint and height return to normal. FIG. 5 shows pseudocode for assigning high, medium and low probabilities or scores for comparing a given input to past correlated sessions to determine whether there is a high, medium or low probability that a current session is associated with a purported past user (identified from an initial or login screen (typically with a user name and password)). As shown, a high probability represents a current input as being plus or minus 5 pixels from an x-coordinate for previous inputs, whereas low probability is plus or minus 15. During an initialization phase, however, these values could be increased to be from, for example, 15-25. Alternatively, the system can simply accept medium or low scores during the ramp-up period.

This above implementation is simple since it only employs determining an x-dimension accuracy of clicking on a displayed button, rather than other dimensions or cursor paths. Another example could use probabilities (such as a Gaussian curve) to score the heat graph. Yet another example could get rid of the decay entirely. In addition, the heat graph algorithm can easily be ported to the y dimension—which is useful for particular interfaces. FIG. 7 shows an example of employing both x and y axis coordinates to analyze user input in a given session when interacting with a computer screen. Of course, the subroutine of FIG. 7 is employed for each session for a given screen by the same user.

The heat graph implementation can also be extended across multiple dimensions. In a 2D implementation the algorithm uses a two dimensional matrix for the heat graph. Any shape for the “heat” part can be used, such as a cube, pyramid, 3-D Gaussian shape, other polygon etc.

Alternatively or additionally, the routine of FIG. 3 may employ additional subroutines for user input. For example, a “click width” may be modified. In this width implementation, using the PROM interface, click locations relative to a target button are used. The PROM interface is set up so that there is a vertical column of buttons, and users can be differentiated based on their click width within these buttons (see e.g., FIG. 8). The width algorithm would, for every session and for every target button in the column, record the x coordinates. A click width is then defined by subtracting the minimum x value from the maximum x value for that button, where the min and max values are adjustable based on security criteria or other factors.

The current width is then compared to previous widths recorded in the user profile; if the current width is similar to those recorded for previous sessions, the score indicate a probable match, while if the current width is not similar then a threat probability is indicated.

The click width implementation can be extended to the y dimension for different interfaces, with the algorithm looking at y coordinates. This embodiment can also be extended to use two dimensions, where x and y coordinates are graphed for all clicks. The tightest fitting circle would then be drawn around them, which would then be compared to the radii from previous sessions.

### IV. Some Additional Features or Alternatives

The click width algorithm or implementation is only one example of various additional features that may be employed with the routine of FIG. 3, or alternatives that may be implemented independently with user input analysis or security systems. For example, one alternative or additional implementation involves “click drift,” which compensates for vagaries of human reaction or input to a given computerized user interface. In this click drift implementation, using the PROM interface, click locations relative to the target button are used. The PROM interface is set up so that there is a vertical column of buttons, and users can be differentiated based on their click drift within these buttons (see e.g., FIG. 8). As users click on the buttons in the column, some clicks tend to drift along the x axis from their starting point. This implementation looks at how a user drifts: do they drift left, right, or not at all.

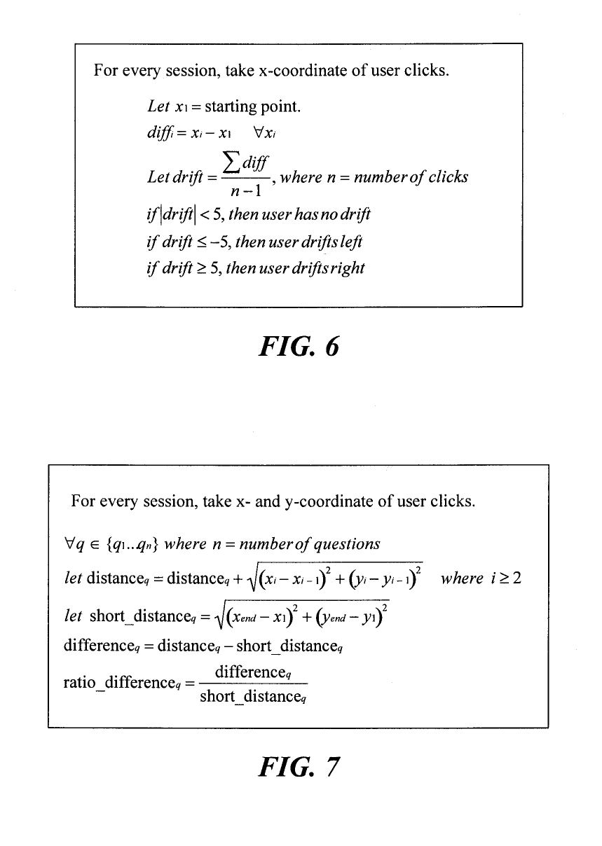

The click drift algorithm would, for every session and for every target button in the column, record the x coordinates. Click drift is defined by finding the difference between the first x coordinate clicked for the first target in the column, and the x coordinate clicked for each subsequent target: if the drift is less than 5 pixels, then the user is said to have no drift. If the drift is less than or equal to negative 5 pixels, then the user is said to drift left; and if the drift is greater than or equal to 5, then the user is said to drift right. FIG. 6 provides an example of some pseudocode for employing this click drift implementation.

The system compares drift (left, right or none) in a current session or authentication phase with drift data recorded previously in the user profile, and assess the probability that the user is authentic. This implementation can be easily implemented for different interfaces and different directions of drift. An interface that has buttons set up in a row may look at vertical drift, while different directions can be used for buttons set up on a diagonal or in a circle. For this implementation, the buttons should be set up in some type of line (row or column).

Another example implementation involves “extra clicks.” In this extra clicks implementation, using the PROM interface, there is an expected number of button clicks (for example, 6 clicks over 5 or 6 screens). The users are expected to click one of the buttons once for each screen; however, some users may click more than the expected number of times on a given button. They may click randomly on the screen, or they may double-click buttons, etc. In this implementation the number of expected mouse clicks is compared to the actual number or mouse clicks, and then compare the result to those recorded previously in the user profile. Thus, the routine of FIG. 3 may be modified to also include a number of clicks a user makes on a given target button, which can be added to the user profile and further used to improve the probability of security of a given session.

Another example implementation involves “extra distance.” In this extra distance implementation, using the PROM interface, an expected number of clicks exist in particular areas. The user's full mouse movement path is recorded along with their clicks, by keeping track of the x and y coordinates with respect to time and with respect to when the buttons were clicked. For every target or question that the user answers, the distance from the starting co-ordinates (where the user clicked previously) to the ending coordinates (where they clicked on the button containing their selection) is recorded. This distance that the user actually moved the cursor is then compared to the straight line path between the two targets.

The difference between the path taken and the shortest possible route is then compared to similar results stored in the user profile. For interfaces where the “short” distance changes significantly for each question (such as PROM, where choices or answers are provided randomly between screens, and where the true user can more readily identify the correct answer, but a deceiver cannot), it will be more useful to look at the ratio of the difference: this normalizes the extra distance to the direct path.

An additional example implementation involves “tracing buttons.” In this tracing button implementation, using the PROM interface, users are presented by a series of buttons in a list. Users move the cursor to the top or the bottom of the list, and then move the cursor over every button as they read them; they would typically move the cursor back to the top of the list.

Using the PROM interface some users have a tendency to trace the column of options, regardless of where their last-clicked button was. The cursor is always returned to either the top or bottom of the column after the last click, followed by it moving over to where the user is reading. This characteristic can be used to distinguish users.

In this implementation the mouse path is checked first for extra distance between button clicks. If the user displays extra distance, then the system checks mouse path for rapid 180 degree (or near thereabout) vertical changes in direction. Where these changes are located (e.g. near the top or bottom of the column of buttons) is also recorded. The implementation looks to see that the path is generally overtop of the buttons (that is the cursor doesn't move much off the columns), and that users who exhibit these traits can be said to be tracing the buttons. The tracing detected or not detected is then compared to similar data stored previously in the user profile.

Additional implementation examples could include rate of curvature, path drift, time measurements, and use of “derived data.” Rate of curvature looks at the difference in how users change directions with the cursor; that is, do they make sharp turns or wide turns? Path drift looks at the tendency of some users to drift off the columns of buttons, whereas others stay on them. The algorithm will track the percentage of time that the path is off the columns. Many possibilities exist for measuring and comparing time based differences. Examples of derived data could include: the speed at which the user traced the path at any given point in time; the acceleration with which the user traced the path at any given point in time; the deviation from prescribed paths (a curve that the user draws, a straight line, or the way that a user traces circular paths); how abruptly the user starts and stops the pointing device; and parameters derived from the coordinates, that can be used to describe the user's tracing.

Under an additional example implementation, an alternative language system, or “Native Language Authentication” (NLA) system modifies existing authentication technologies through multi-language translation of all user related materials or screens. With the Native Language Authentication system, users may complete a second phase of authentication in a language they have chosen during initial enrolment, such as their native language.

Current use of language translation during authentication has been directed to the usability of a typical user in the country that the website is designed either in or for. The user is not given a choice among a large set of world languages. Instead, most security systems tend to provide text in the language(s) of the country of origin. Canada, therefore, tends to have banking and internet services in English, French or both. Similarly, China presents information mainly in its national languages. In addition, language preference is used in systems to enhance the ease of use, rather than for enhancing security. This bias is evident in the very common practice of allowing the user to choose their preferred language (if a selection is allowed) at each and every login.

The NLA system balances usability and security issues. Firstly, NLA asks users to select their preferred language during a first enrolment session. So instead of the country of origin deciding the languages that can be used, the user is given a broad list to choose from. All of the instructions, options and information that is shown during that session will then be in that user's chosen language. Secondly, no subsequent language requests are made during later sessions—all future session after enrolment automatically present all of the queries and selection options in the user's initially chosen preferred language.

This additional variable increases the overall security of the system. Users have the advantage of not having to re-select an option that they have already made a decision about. Additionally, hackers, or non-users attempting to gain access to another person's account must be able to read material in that user's preferred language. Although this new provision does not increase the security to all accounts, it does increase security to some accounts. In addition, it does not have any negative impact on usability, and can positively affect the usability for users who consistently have to choose their language from a list prior to entering their authentication credentials.

Similarly it will not have an impact on accounts that are secured by a single factor like a password or a static biometric like a fingerprint. NLA will impact systems that use knowledge structure as a component of the authentication process. Simple knowledge queries like “mother maiden name”, “favorite pet” and “travel destination” can provide a higher level of security if the questions are always shown in the user's preferred language. Stronger knowledge based questions, such as questions provided under the PROM system will acquire even higher benefits.

Further, user's and non-user's response patterns will be markedly different because the non-user must translate queries and selection choices. Also, simply the novelty of seeing information in an unexpected language will contribute to an erratic response pattern that can be used to quickly alert the system to non-user penetration attempts. Thus, the mouse or user input tracking and analysis techniques described above can be readily implemented with NLA to provide further security benefits.

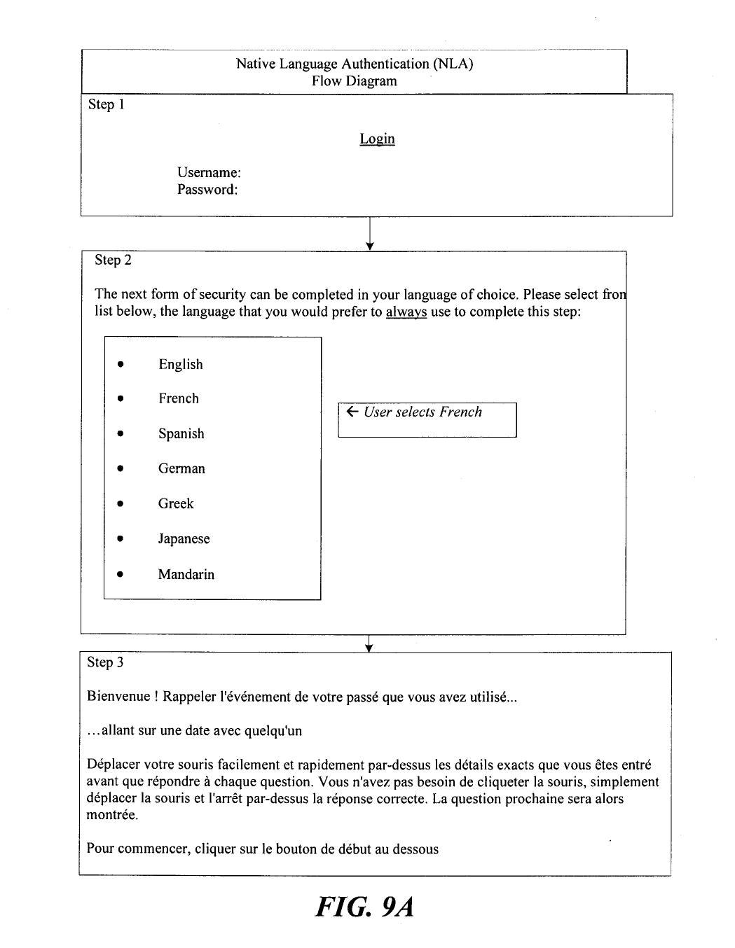

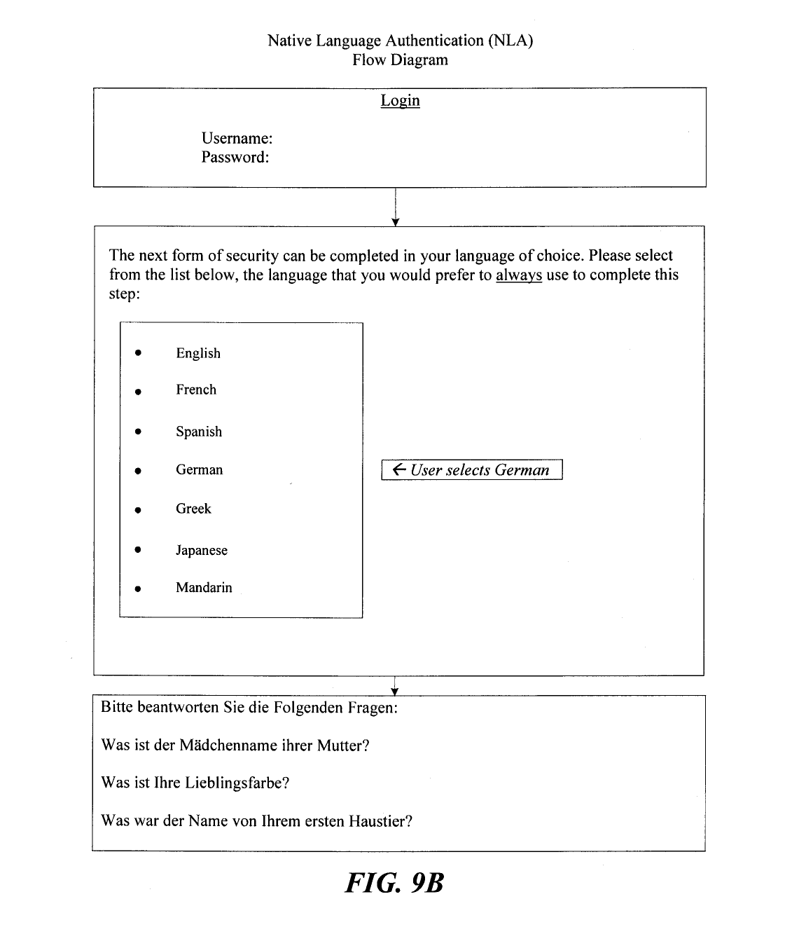

With the Native Language Authentication method, the user begins by entering his or her initial credentials such as user name and password. See “step 1” in FIGS. 9A and 9B. This is done in the standard language of the system, typically the language of the country or institution. For the second phase of authentication, the user is able to choose from a selection of languages. Once this decision is made, the remainder of the authentication session, and all other authentication sessions that follow, are completed in the language of choice. All instructions, prompts and responses made during the second stage of authentication will be done in the user's chosen language. This system is ideal for multiple entry knowledge based systems with challenge questions or more complex knowledge based criteria. FIGS. 3A and 3B show examples of this system.

The embodiments of this alternative may include, but are not limited to, implementations in banking transactions. Users begin by presenting their user identification such as user name and password, passcode or bank card personal identification number. Following this, the system looks up the language settings attached to the user identification. Users are then presented with a knowledge-based question in their previously chosen language and must enter answers to challenges in the same language. The security advantage is maximized by combining NLA with a high security knowledge system, like PROM and the above system, and a system that monitors changes in how data is entered (See, e.g., U.S. patent application Ser. No. 11/737,692 (atty. docket no. 60783.8002.US01) by Martin Renaud, entitled SYSTEM AND METHOD ON ENHANCING USER AUTHENTICATION THROUGH ESTIMATION OF FUTURE RESPONSE PATTERNS, filed 19 Apr. 2007.)

In another embodiment, a user of an automatic teller machine (ATM) would be given the language option at the time that he or she initially registers a personal identification number (PIN) (possibly when initiating an on-line banking account). Subsequent transactions using that bank card at an ATM will result in subsequent information and transaction requests occurring within the user's chosen language. This system would require that a simple modification be introduced to current presentation formats of transaction details on the ATM user interface display. Currently the location of items on that display are fixed so that practiced users do not really have to read the information to know which buttons to select for their common transactions. To facilitate a secure environment in multiple languages, this interface design is modified to randomize the location of the items presented on the screen. Only people capable of reading a user's chosen language would then be able to readily conduct business using a particular card. This system could drastically reduce the effectiveness of debit card theft, debit card copying and other forms of ATM related crimes.

In another embodiment of the invention, the Native Language Authentication system may be employed with cell phones or personal digital assistants (PDA), whereby an initial screen may be provided in one language, but any subsequent screens display the user's chosen language. Further embodiments of the invention may employ the Native Language Authentication system to other electronic devices, including laptops, DVD players, televisions, any computer noted above, and so forth.

An advantage of this NLA authentication method is that the user can complete the session easily, while non-users have the additional requirement of knowing the specific language. This modification, therefore, enhances both security and usability. With other authentication systems, an intruder typically knows what to expect, however, with the Native Language Authentication method, a second variable is added which reduces the likelihood that the intruder's attack will be successful. By adding one more variable that the non-user must overcome, the system is more secure. Most existing authentication technologies employ only a single native language based on the system's country of origin, not the user. This renders the system more vulnerable to attacks. The Native Language Authentication system enhances security by increasing the difficulty for intruders.

As explained above, a modification can be made to any authentication environment in which upon enrollment the user chooses a language, from a list of options, for all future transactions with the system. This modification can be implemented into knowledge based authentication system like PROM, where the user will enter an initial identification claim (password, credit card number etc.) then the authentication environment will present all subsequent information in a user's chosen language. For example, if during initial enrollment the user selected “GERMAN” as a preferred language, all of the PROM instructions, queries and options would be shown in that language. Simpler systems, like those that request an answer to one of a few personal questions (like mother's maiden name, favorite pet etc) will also be enhanced by presenting these questions in the user's native language.

Overall, aspects of the above system may employ, a challenge-response, question-answer system, where questions are delivered in a manner that permits answers to be selected from graphically rendered menus by novice users, and provided via an un-prompted, learned gesture by expert users. Only intended users can produce system-anticipated gestures, which provide a highly discriminating biometric, corresponding to cognitive states of users. This approach not only addresses known shortcomings of simple challenge-response systems by simultaneously increasing both entropy and memorability, but also solves inherent problems associated with biometrics by exploiting ubiquity of brain and kinesthetic function and allowing for privacy-motivated user-driven biometric update. A corollary is that the signature-gestures supported by the system can be used pseudonymously in the pursuit of privacy.

The transition between novice and expert is encouraged by arranging menu items so that graphical and manual actions performed in making the correct response are invariant between questions. Thus, in one embodiment, positions of buttons for correct answers to all life-memory challenge questions are located in the same way, ensuring that the response gesture will be isomorphic for all questions: this will result in a single learned user gesture. Over time, and many question-answer iterations, the user's kinesthetic loop will have been trained to provide the correct answer, irrespective of the question. The “answer” has been “memorized” in more than one way, on more than one level. The gesture can be thought of as a cognometric signature, by analogy to traditional handwritten signatures.

Thus, one embodiment uses a modified form of PROM to deliver a sequence of menus allowing users to authenticate themselves by choosing correct answers from amongst distractors or wrong answers, as described above for PROM. However, in this modified version, the position of the correct answer is invariant with respect to its distractors: every time a particular memory is exploited by the system and presented to the user, the menus associated with that memory are identical. Not only can the user memorize the positions of the correct answers, the user is initially encouraged to do so, and eventually required to do so. The system interprets the gesture and assess it for authenticity more or less in isomorphism to its role with PROM.

The net effect of repeated authentication sessions using the same challenge-response memory menu is that the user will gradually learn a repeatable motion, or gesture. The gesture can be reproduced by experienced users even in the absence of the menu prompts.

In another embodiment, the correct answers for each question appear in the same place, but in different positions for different memories: this will result in multiple learned gestures—one for each memory. These gestures are said to be cognometrically indexed, as each one corresponds to a distinct vivid memory and its set of challenge-response questions and answers.

In another embodiment, the system uses circular menus centered on the last mouse event to produce more complex gestures. Circular menus may offer a number of advantages over their now-traditional drop-down rectilinear cousins.
uniform distance to each target and relatively larger target selection area can offer quicker and more reliable selection, particularly on the small screens and stylus input devices associated with mobile and handheld devices
a sequence of selections from a hierarchy of circular menus constitutes a particular track of hand motions: if the hierarchy is consistent, this track can be reproduced at each usage and can be quickly learned by a novice user, and can lead to enhanced expert usage
the circular menu need be displayed only if the user pauses during expected input: these “self-revealing” circular menus cater to both novice and expert users.

Some or all of the aspects of the above system may be employed with other security measures. For example, the above system may be incorporated with, or communicate with, system awareness software to track sources of non-users, thus speeding the potential of shutting off all access attempts from these sources and aiding investigators in apprehending those practicing identity fraud and identity theft. An example of system awareness software is found in U.S. patent application Ser. No. 11/682,769 (attorney docket no. 60783.8009), filed 6 Mar. 2007, entitled “Globally Aware Authentication System,” by inventor Martin Renaud, and assigned to the present assignee.

### IV. CONCLUSION

Described above is a computer-implemented system that monitors and assesses user response parameters, and compares them against previously stored parameters associated with that user. The stored parameters are measured during user initialization, and constantly, sporadically, or periodically updated as more user response data is collected. The response parameters to be recorded may include response time to a query, cursor movement patterns, cursor movement rates, cursor hover patterns, clicking patterns, rate of curvature in cursor movement, etc. The responses are measured during user authentication sessions, are transparent to the user, and are stored in the associated user profile. Using various methods, some of which are described in detail below, the current response parameters are compared against previously-stored parameters. This provides an additional level of security, in addition to the authorization mechanism(s) that the user is both conscious of and responding to.

In general, the detailed description of embodiments of the invention is not intended to be exhaustive, or to limit the invention to the precise form disclosed above. While specific embodiments of, and examples for, the invention are described above for illustrative purposes, various equivalent modifications are possible within the scope of the invention, as those skilled in the relevant art will recognize. For example, while processes are presented in a given order, alternative embodiments may perform routines having steps in a different order, and some processes may be deleted, moved, added, subdivided, combined, and/or modified. Each of these processes may be implemented in a variety of different ways. Also, while processes are at times shown as being performed in series, these processes may instead be performed in parallel, or may be performed at different times.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the invention reside on a server computer, while corresponding portions reside on a client computer such as a mobile or portable device, and thus, while certain hardware platforms are described herein, aspects of the invention are equally applicable to nodes on a network.

The teachings of the invention provided herein can be applied to other systems, not necessarily the system described herein. The elements and acts of the various embodiments described herein can be combined to provide further embodiments.

These and other changes can be made to the invention in light of the above Detailed Description. While the above description describes certain embodiments of the invention, and describes the best mode contemplated, no matter how detailed the above appears in text, the invention can be practiced in many ways. Details of the system may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied as a means-plus-function claim under 35 U.S.C. § 112, sixth paragraph, other aspects may likewise be embodied as means-plus-function claims. Accordingly, the inventors reserve the right to add additional claims after filing the application to pursue such additional claim forms for other aspects of the invention.

I/We claim:

1. A computer-implemented user authentication method, the method comprising:
receiving input data, wherein the input data includes:
login information identifying a user profile associated with a user;
at least a portion of the user profile, wherein the user profile comprises a history of previously recorded gesture data associated with the user and stored in the user profile;
current input device data, wherein the current input device data is associated with manual user manipulation of an input device used to control or track cursor movement, and wherein the cursor movement is associated with a displayed graphical objective shown on a display screen and prompting the user to manually manipulate the input device to fulfill the displayed objective;
recording data points based on the current input device data, wherein the recorded data points include:
at least one axis of coordinates for movement of the cursor on the display screen, or
force applied in moving the cursor with respect to time, or
location, number, and frequency of clicks within the display screen;
analyzing the input data, wherein the analyzing includes:
comparing the current input device data with previously recorded gesture data in the user profile, and
determining an output related to an authenticity that the current input device data corresponds to the user associated with the user profile; and,
producing human-readable output relating to the analyzing.

2. The method of claim 1, wherein the recorded data points include at least one of: response time to a query, cursor movement patterns, cursor movement rates, cursor hover patterns, clicking patterns, or rate of curvature in cursor movement, and wherein the human-readable output includes at least one alert to users of a local network and at least one report to a system administrator associated with the local network.

3. The method of claim 1, further comprising generating a heat graph or Gaussian curve distribution of the previously recorded gesture data and the current input data.

4. The method of claim 1, further comprising determining click locations relative to buttons or targets displayed on the screen, including sections or portions of the displayed buttons or targets, and as compared to previously recorded gesture data in the user profile.

5. The method of claim 1, further comprising comparing an input device click to a center of an input button displayed on the screen to determine a click drift from the center of an input button as compared to previously recorded gesture data in the user profile.

6. The method of claim 1, further comprising determining a number of clicks provided in the current input device data and comparing the determined number of clicks to an expected number of clicks for an on-screen task and to previously recorded gesture data in the user profile.

7. The method of claim 1, further comprising receiving x and y coordinates of input device movement path, determining a distance of cursor movement, and comparing the determined distance to a straight line path between two displayed targets and to previously recorded gesture data in the user profile.

8. The method of claim 1, further comprising determining cursor movement relative to an ordered arrangement of displayed buttons or targets, and comparing the determined movement to previously recorded gesture data in the user profile.

9. The method of claim 1, further comprising: receiving x and y coordinates of input device movement path; determining a cursor movement distance between clicks; if extra distance beyond expected distance is detected, then checking for approximately 180 degree changes in direction with respect to an ordered arrangement of displayed buttons or targets and previously recorded gesture data in the user profile.

10. The method of claim 1, further comprising comparing a rate of curvature, path drift, time measurements, or derived data with previously recorded gesture data in the user profile, wherein the rate of curvature comprises a difference in changes of cursor direction, wherein the path drift comprises a drift off of an ordered arrangement of displayed buttons or targets, wherein the time measurements comprise time differences between cursor movements and/or clicks, and wherein the derived data comprises: a speed at which the cursor traces at least a portion of a displayed path, an acceleration at which the cursor traces at least a portion of a displayed path, a deviation from at least a portion of a displayed path, how abruptly a cursor starts and stops, or parameters derived from the at least one axis of coordinates of cursor movement.

11. A method of providing access to a standard data processing device, wherein the data processing device has at least one primary function unrelated to user authentication, and wherein the data processing device includes a display screen and a user input device, the method comprising:
presenting on the display screen a displayed objective for a user to pursue;
receiving user input via the user input device as pursuit of the displayed objective, wherein the user input includes manual manipulation of the user input device, and wherein the received user input is not a user signature;
comparing the received user input to a user profile representing prior manual manipulation of the user input device in pursuit of the displayed objective; and,
determining whether to provide access to the at least one primary function of the data processing device based on the comparison of the received user input to the user profile.

12. The method of claim 11 wherein the displayed objective is to answer a series of personal questions by selecting one of several regularly aligned buttons associated with several different answers for each personal question.

13. The method of claim 11 wherein the data processing device is a personal computer, wherein the user input device is a mouse, and wherein the user input is a path of a cursor moved along a prescribed path based on mouse movement.

14. A system to provide user authenticating data associated with a current user, the system comprising:
a user input portion configured to receive manual user input, wherein the user input portion provides authentication and non-authentication input data;
a memory storing instructions;
a display portion; and,
a data processing portion coupled to the input and output portions, and coupled to the memory to execute the instructions, wherein the instructions configure the system to:
present information to the user via the output portion, wherein the presented information includes at least one displayed object and an objective for the user to pursue based on the displayed object through manual input of the user input portion;
receive manual input via the user input portion based on pursuit of the objective relative to the displayed object;
compare the received manual input to stored data representing previously received manual input from the user input portion based on previous pursuits of the objective relative to the displayed object for a single user; and
output authentication data based on the comparison.

15. The system of claim 14, wherein the instructions further configure the system to:
present information to the user via the output portion in one language understandable both to the user and to a large population or majority of individuals in a geographic region in which the system is located; and
present, via the output portion, at least one question or at least several choices to the user in an other language, wherein the other language is predetermined, is understandable by the user, and is less commonly understood by the individuals in the geographic region.

16. The system of claim 14 wherein the objective is to answer a personal question by selecting one of several regularly aligned buttons associated with several different answers.

17. The system of claim 14 wherein the user input portion is a mouse, and wherein the user input is a path of a cursor moved along a prescribed path based on mouse movement.

18. The system of claim 14 wherein the output of authentication data includes determining a score associated with a likelihood that the current user is associated with the previously received manual input.

19. A system for providing access to a user at a data processing device or computer, the system comprising:
means for presenting information to the user in one language understandable both to the user and to a large population or majority of individuals in a geographic region in which the data processing device or computer is located;
means for receiving initial user input at the data processing device or computer;
means for based on the initial user input, presenting at least one question or at least several choices to the user in an other language, wherein the other language is predetermined, is understandable by the user, and is not commonly understood in the geographic region;
means for receiving subsequent user input at the data processing device or computer; and
means for permitting the user to have access to user-desired information if the subsequent user input is acceptable.

20. The system of claim 19, further comprising means for presenting both at least one question and several choices as answers to the question, and wherein the choices are presented in different orders at different times.

21. The system of claim 19, further comprising:
means for providing to the user, at an initial stage, a list of languages to choose from;
means for receiving a user selection from the list; and
means for setting the other language based on the received user selection.
